(19) United States
(12) Patent Application Publication
(10) Pub. No.: US 2026/0261882 A1
(43) Pub. Date: Sep. 3, 2026

(54) PERFORMANCE OF LAYER-1 (L1) MEASUREMENT OPERATIONS FOR SERVING CARRIERS BASED ON A PRIORITY ASSIGNED TO A CARRIER GROUP OF MULTIPLE CARRIER GROUPS

(71) Applicant: Apple Inc., Cupertino, CA (US)

(72) Inventors: Qiming Li, Beijing (CN); Dawei Zhang, Saratoga, CA (US); Manasa Raghavan, Sunnyvale, CA (US); Xiang Chen, Campbell, CA (US); Yang Tang, San Jose, CA (US); Jie Cui, San Jose, CA (US)

(21) Appl. No.: 18/881,676

(22) PCT Filed: Jul. 7, 2022
(86) PCT No.: PCT/CN2022/104402

§ 371 Date: Jan. 6, 2025

(51) Int. Cl. H04W 24/08

(52) U.S. Cl. CPC H04W 24/08

(57) ABSTRACT

A user equipment (UE) includes a transceiver and a processor. The processor is configured to receive, via the transceiver and from a base station, configuration information corresponding to a plurality of serving carriers, the configuration information including indications of a plurality of carrier groups, and a priority corresponding to each carrier group of the plurality of carrier groups. Each carrier group of the plurality of carrier groups includes a different subset of the plurality of serving carriers. The processor is configured to perform measurements on the plurality of serving carriers based on the priority associated with each carrier group of the plurality of carrier groups.

### TECHNICAL FIELD

This application relates generally to wireless communication systems, including methods and systems for performing layer-1 measurement operations by a user equipment (UE), for a number of serving carriers, based on a priority assigned to a carrier group of multiple carrier groups.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 602.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANS can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows an example wireless communication system, according to embodiments described herein.

FIG. 2 illustrates a number of serving carriers as grouped in multiple carrier groups, according to embodiments described herein.

FIG. 3 illustrates assignment of a number of carrier groups and searchers for performing cell search operations, according to embodiments described herein.

FIG. 4 illustrates an example flow-chart of operations that may be performed by a UE, according to embodiments described herein.

FIG. 5 illustrates another example flow-chart of operations that may be performed by a UE, according to embodiments described herein.

FIG. 6 illustrates an example flow-chart of operations that may be performed by a base station, according to embodiments described herein.

FIG. 7 illustrates another example flow-chart of operations that may be performed by a base station, according to embodiments described herein.

FIG. 8 illustrates an example architecture of a wireless communication system, according to embodiments described herein.

FIG. 9 illustrates a system for performing signaling between a wireless device and a network device, according to embodiments described herein.

### DETAILED DESCRIPTION

In the present disclosure, various embodiments are related to performing search and measurement operations for a number of serving carriers using a number of searchers of a user equipment. Currently, as described in clause 3.6.2.1 of 3GPP Technical Specification (TS) 38.133, the number of serving carriers capabilities is 10, and is under consideration to increase from its current number 10 to another number, for example, 16. The number of serving carriers capabilities of 16 corresponds to new radio (NR) downlink (DL) component carriers or serving carriers (CCs) in total, while having 1 uplink (UL) serving carrier (or 2 UL serving carriers, depending on whether supplemental UL (SUL) is configured or not) in a primary cell (PCell) and up to 8 UL serving carriers (or 9 UL serving carriers, depending on whether SUL is configured or not) for secondary cells (SCells).

As the number of serving carriers (or CCs) is increased, measurement latency associated with various measurements may also increase because of the increase in a measurement sample interval for each CC. With the increase in the number of CCs, the sample interval on each layer may also increase significantly. The increase in sample interval may cause an automatic gain control (AGC) to be redefined, and the UE may lose fine time and frequency tracking on the target cell.

Further, measurements related to RX beam sweeping, and so on, have an additional delay in a frequency range-2 (FR2), which may affect measurement performance and UE mobility. A UE with two searchers may perform search and measurement operations on two CCs simultaneously. However, when the number of CCs is increased, with two searchers, the cell search delay and measurement period may increase. As a result, the UE may not be able find a suitable neighbor cell timely. Further, one of the two searchers is fixed on the PCell, while the other searcher is used for SCells, in a round robin or other ordering.

Accordingly, various embodiments, described herein, provide a solution to perform search and measurement operations on the CCs, which may allow the UE to find a suitable neighbor cell timely. As described herein, in some embodiments, more than two searchers may be used for search and measurement operations, while the multiple CCs are grouped together in multiple carrier groups. Each carrier group of the multiple carrier groups may include one or more CCs, and each carrier group may be assigned a respective priority and a respective searcher. Accordingly, each searcher of the multiple searchers may perform search and measurement operations based on a priority assigned to each carrier group.

Reference will now be made in detail to representative embodiments/aspects illustrated in the accompanying drawings. The following description is not intended to limit the embodiments to one preferred embodiment. On the contrary, it is intended to cover alternatives, combinations, modifications, and equivalents as can be included within the spirit and scope of the described embodiments as defined by the appended claims.

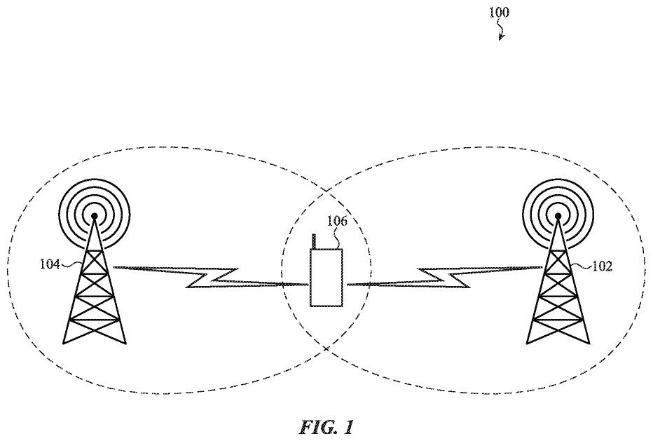

FIG. 1 shows an example wireless communication system, according to embodiments described herein. As shown in FIG. 1, a wireless communication system 100 may include base stations 102 and 104, and a UE 106. The UE 106 may be in a serving cell of a base station, e.g., the base station 102. In some embodiments, the base station 102 and/or 104 may be an eNb, an eNodeB, a gNodeB, or an access point (AP) in a radio access network (RAN) and may support one or more radio access technologies, such as 4G, 5G new radio (5G NR), and so on. The UE 104 may be a phone, a smart phone, a tablet, a smartwatch, an Internet-of-Things (IoT), and so on.

In some embodiments, and by way of a non-limiting example, as shown in the wireless communication system 100, the UE 106 may be connected with the base station 102 and/or the base station 104 in a carrier aggregation (CA) mode of multiple serving carriers. The number of serving carriers may be, as described herein, 10, 16, or more. The UE 106 may thus send and/or receive data over one or more component carriers of different frequency bands or frequency ranges, for example, FR1-1, FR1-2, FR2-1, and/or FR2-2. In some cases, the UE 106 may be connected with more than one base station in CA mode and/or non-CA mode. In some embodiments, and by way of a non-limiting example, the UE 106 may also be connected with the base station 102 and/or the base station 104 in a non-CA mode, over multiple CCs.

In some embodiments, as the UE is being served by multiple CCs, the UE may be required to perform measurement operations on each of the multiple CCs. Timing of measurement operations may be improved for a UE having two or more searchers based on each searcher assigned to one or more carrier groups for performing search and measurement operations. Each carrier group of the one or more carrier groups may include one or more CCs of the multiple CCs. Each carrier group assigned to a searcher may have a particular priority value, and the searcher may perform search and measurement operations according to the particular priority value assigned to the carrier group.

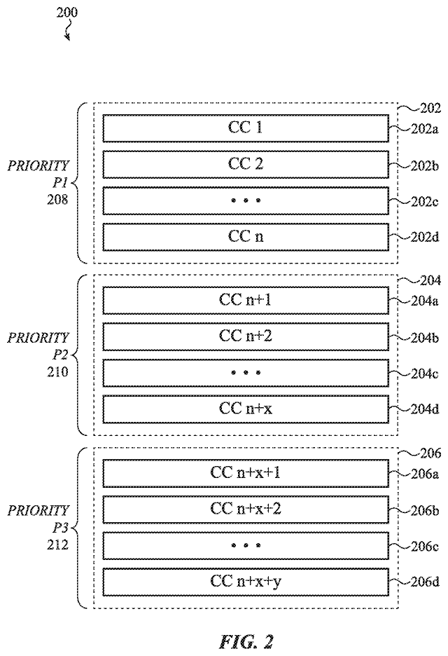

FIG. 2 illustrates a number of serving carriers as grouped in multiple carrier groups, according to embodiments described herein. As shown in a diagram 200, multiple CCs are divided in multiple carrier groups, for example, a carrier group 202, a carrier group 204, and a carrier group 206, and so on. Each carrier group of multiple carrier groups may include one or more CCs. For example, the carrier group 202 may include CC1 . . . . CCₙ 202a-202d. Similarly, the carrier group 204 may include CCₙ₊₁ . . . . CCₙ₊ₓ 204a-204d, and the carrier group 206 may include CCₙ₊ₓ₊₁ . . . CC_{n+x+y} 206a-206d. Here, each of n, x, and y, is a positive integer.

In some embodiments, and by way of a non-limiting example, a number of carrier groups may be limited to a predetermined number of carrier groups, and a number of CCs in each carrier group may be limited to a predetermined number of CCs. Each of the carrier group may be assigned to a different searcher or the same searcher. Each carrier group may be further assigned a particular priority value. For example, the carrier group 202 may be assigned a priority P1 208, the carrier group 204 may be assigned a priority P2 210, and the carrier group 206 may be assigned a priority P3 212. Accordingly, if the carrier groups 202, 204, and 206, are assigned to the same searcher, the searcher assigned to the carrier groups 202, 204, and 206 may perform search and measurement operations according to a respective priority assigned to each carrier group.

For example, the priority P1 208 assigned to the carrier group 202 is 0.5 and the priority P2 210 assigned to the carrier group 204 is 0.4, then the carrier group 202 has a higher priority over the carrier group 204. A searcher may, therefore, perform search and measurement operations on the carrier group 202 at a higher priority compared with other carrier groups also assigned to the particular searcher. When priority for each carrier group is added, it will be 1. Accordingly, the priority P3 212 of the carrier group 206 is 0.1, as P1+P2+P3 has to be 1. Accordingly, a carrier group having high priority CCs may be assigned a higher priority value, and mobility performance for the high priority CCs may be guaranteed.

Accordingly, in some embodiments, and by way of a non-limiting example, a measurement period for intra-frequency measurements with and/or without gaps, and for FR1 and/or FR2, may depend on a number of CCs in a carrier group, and a priority assigned to the carrier group, in addition to a discontinuous reception (DRX) cycle time. In the table below, a measurement period for intra-frequency measurements without gaps for a UE in a frequency range of frequency range-1 (FR1) for corresponding to various DRX cycle times is described. In the table below, CSSF_{intra_group_i} represents a number of carriers configured in a carrier group, and Pᵢ represents a priority assigned to the carrier group.

| DRX Cycle | T_{SSB}_{_{—}}ₘₑₐₛᵤᵣₑₘₑₙₜ_{_{—}}_{period}_{_{—}}ᵢₙₜᵣₐ |
|---|---|
| No DRX | max(200 ms, ceil (5 × Kₚ) × SMTC_{period})^{Note 1} × CSSFᵢₙₜᵣₐ_{_{—}}_{group}_{_{—}}ᵢ × (1/Pᵢ) |
| DRX Cycle <= 320 | max(200 ms, ceil (1.5 × 5 × Kₚ) × max (SMTC_{period}, |
| milliseconds (ms) | DRX Cycle)) × CSSFᵢₙₜᵣₐ_{_{—}}_{group}_{_{—}}ᵢ × (1/Pᵢ) |
| DRX Cycle > 320 ms | ceil (5 × Kₚ) × DRX Cycle × CSSFᵢₙₜᵣₐ_{_{—}}_{group}_{_{—}}ᵢ × (1/Pᵢ) |

^{Note 1}
If different SMTC periodicities are configured for different cells, the SMTC period in the requirement is the one used by the cell being notified.

In some embodiments, and by way of a non-limiting example, each CC of multiple CCs in a carrier group may be further assigned a respective priority, and the searcher may perform measurement operations for each CC in the carrier group based on the respective priority assigned to each CC in the carrier group.

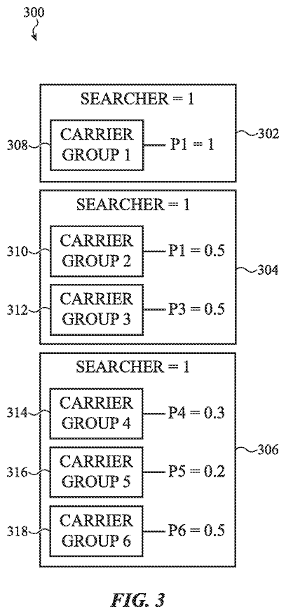

FIG. 3 illustrates an assignment of a number of carrier groups and searchers for performing cell search operations, according to embodiments described herein. As shown in a diagram 300, a UE may have multiple searchers, for example, a searcher-1 302, a searcher-2 304, and/or a searcher-3 306, and so on. Each searcher may be assigned one or more carrier groups for performing search and measurement operations on the one or more CCs of each carrier group. The searcher may perform search and measurement operations on each carrier group assigned to the searcher based on a particular priority assigned to the respective carrier group.

In some embodiments, and by way of a non-limiting example, multiple CCs may be grouped in different carrier groups. Each carrier group may thus have a subset of multiple CCs. Each subset of multiple CCs may be unique. For example, a carrier group-1 308 may be the only carrier group assigned to the searcher-1 302, while a carrier group-2 310 and a carrier group-3 312 may be assigned to the searcher-2 304. A carrier group-4 314, a carrier group-5 316, and a carrier group-6 318 may be assigned to the searcher-3 306. By way of a non-limiting example, the carrier group-1 308 assigned to the searcher-1 302 may have a priority value of 1, since it is the only carrier group assigned to the searcher-1 302. The carrier group-2 310 and the carrier group-3 312, each may be assigned an equal priority, e.g., 0.5. Accordingly, searcher-2 304 may perform search and measurement operations in a round robin manner for the carrier group-2 310 and the carrier group-3 312. In one example, the carrier group-4 314, the carrier group-5 316, and the carrier group-6 318 associated with the searcher-3 306 may be assigned a priority of 0.3, 0.2, and 0.5, respectively. In other words, the carrier group-6 318 has a higher priority over the carrier group-4 314 and the carrier group-5 316, and the carrier group-4 314 has a higher priority over the carrier group-5 316.

In some embodiments, a mapping of a searcher and associated one or more carrier groups with a respective priority for each carrier group may be received by a UE in radio resource control (RRC) signaling or a MAC control element (MAC CE) from a base station. However, when a respective priority for one or more carrier groups assigned to a searcher is not configured by the base station, the UE may assume each carrier group assigned to the searcher has an equal priority, and may therefore perform search and measurement operations in a round robin manner for each carrier group.

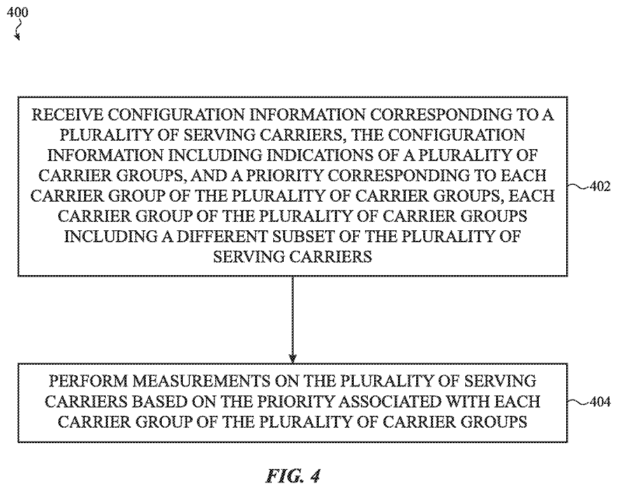

FIG. 4 illustrates an example flow-chart of operations that may be performed by a UE, according to embodiments described herein. As shown in a flow-chart 400, at 402, a UE may receive configuration information corresponding to a plurality of serving carriers (CCs). The configuration information may include indications of a plurality of carrier groups, and a priority assigned to each carrier group of the plurality of carrier groups. As described herein, the configuration information may be received by the UE via RRC signaling and/or a MAC CE. Each carrier group of the plurality of carrier groups may include a different subset of a plurality of CCs. In some embodiments, and by way of a non-limiting example, each subset of the plurality of CCs may be unique. In other words, each CC of the plurality of CCs may be present in not more than one carrier group.

In some embodiments, and by way of a non-limiting example, the indications may identify a set of one or more CCs included in a carrier group by at least one service cell ID, or at least one carrier frequency associated with a respective at least one CC. The CC may be in a frequency range of frequency range-1 (FR1) or a frequency range of frequency range-2 (FR2).

In some embodiments, and by way of a non-limiting example, a total number of CCs in a carrier group of the plurality of carrier groups may be limited to a predetermined number of serving carriers, and/or a total number of carrier groups of the plurality of carrier groups may be limited to a predetermined number of carrier groups.

At 404, a UE may perform measurements on the plurality of serving carriers based on the priority associated with each carrier group of the plurality of carrier groups. As described herein, a respective priority for each carrier group of the plurality of carrier groups may be received by the UE in configuration information at 402. However, in some embodiments, and by way of a non-limiting example, when the priority corresponding to each carrier group is not received by the UE in the configuration information, the UE may perform measurement operations in a round robin manner for each carrier group of the plurality of carrier groups.

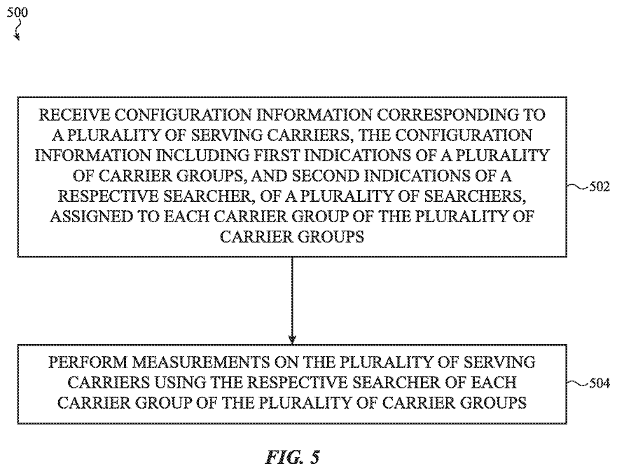

FIG. 5 illustrates another example flow-chart of operations that may be performed by a UE, according to embodiments described herein. As shown in a flow-chart 500, at 502, a UE may receive configuration information corresponding to a plurality of serving carriers (CCs). The configuration information may include first indications of a plurality of carrier groups, and second indications of a respective searcher, of a plurality of searchers, assigned to each carrier group of the plurality of carrier groups.

The configuration information may also include, in some embodiments, and by way of a non-limiting example, a priority assigned to each carrier group of the plurality of carrier groups in which the respective searcher may perform search and measurement operations. In some embodiments, a searcher may be assigned more than one carrier group.

As described herein, the configuration information may be received by the UE via RRC signaling and/or a MAC CE. Each carrier group of the plurality of carrier groups may include a different subset of a plurality of CCs. In some embodiments, and by way of a non-limiting example, each subset of the plurality of CCs may be unique. In other words, each CC of the plurality of CCs may be present in not more than one carrier group.

In some embodiments, and by way of a non-limiting example, the indications may identify a set of one or more CCs included in a carrier group by at least one service cell ID, or at least one carrier frequency associated with a respective at least one CC. The CC may be in a frequency range of frequency range-1 (FR1) or a frequency range of frequency range-2 (FR2).

In some embodiments, and by way of a non-limiting example, a total number of CCs in a carrier group of the plurality of carrier groups may be limited to a predetermined number of serving carriers, and/or a total number of carrier groups of the plurality of carrier groups may be limited to a predetermined number of carrier groups.

At 504, a UE may perform measurements on the plurality of serving carriers using the respective searcher of each carrier group of the plurality of carrier groups, and based on the priority associated with each carrier group of the plurality of carrier groups. As described herein, a respective priority for each carrier group of the plurality of carrier groups may be received by the UE in configuration information at 502. However, in some embodiments, and by way of a non-limiting example, when the priority corresponding to each carrier group is not received by the UE in the configuration information, the searcher of the UE may perform search and/or measurement operations in a round robin manner for each carrier group of the plurality of carrier groups.

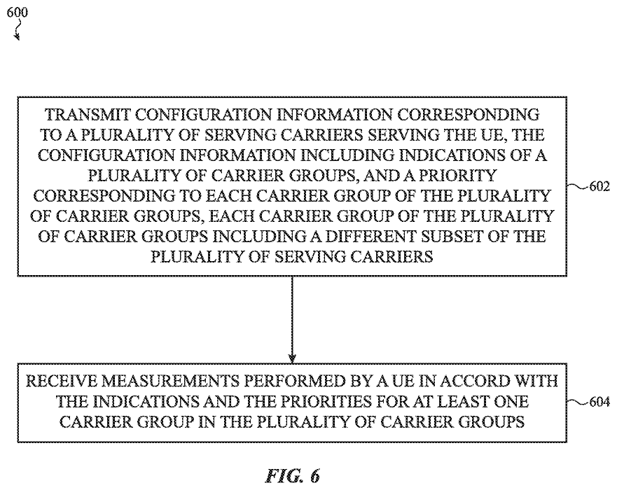

FIG. 6 illustrates an example flow-chart of operations that may be performed by a base station, according to embodiments described herein. As shown in a flow-chart 600, at 602, a base station may transmit to a UE configuration information corresponding to a plurality of serving carriers (CCs). The configuration information may include indications of a plurality of carrier groups, and a priority assigned to each carrier group of the plurality of carrier groups. As described herein, the configuration information may be transmitted to the UE via RRC signaling and/or a MAC CE. Each carrier group of the plurality of carrier groups may include a different subset of a plurality of CCs. In some embodiments, and by way of a non-limiting example, each subset of the plurality of CCs may be unique. In other words, each CC of the plurality of CCs may be present in not more than one carrier group.

In some embodiments, and by way of a non-limiting example, the indications may identify a set of one or more CCs included in a carrier group by at least one service cell ID, or at least one carrier frequency associated with a respective at least one CC. The CC may be in a frequency range of frequency range-1 (FR1) or a frequency range of frequency range-2 (FR2).

In some embodiments, and by way of a non-limiting example, a total number of CCs in a carrier group of the plurality of carrier groups may be limited to a predetermined number of serving carriers, and/or a total number of carrier groups of the plurality of carrier groups may be limited to a predetermined number of carrier groups.

At 604, the base station may receive, from the UE, measurements performed on the plurality of serving carriers, by the UE, based on the priority associated with each carrier group of the plurality of carrier groups. As described herein, a respective priority for each carrier group of the plurality of carrier groups may be transmitted, by the base station, to the UE, in configuration information at 602. However, in some embodiments, and by way of a non-limiting example, when the priority corresponding to each carrier group is not included in the configuration information, the UE may perform measurement operations in a round robin manner for each carrier group of the plurality of carrier groups.

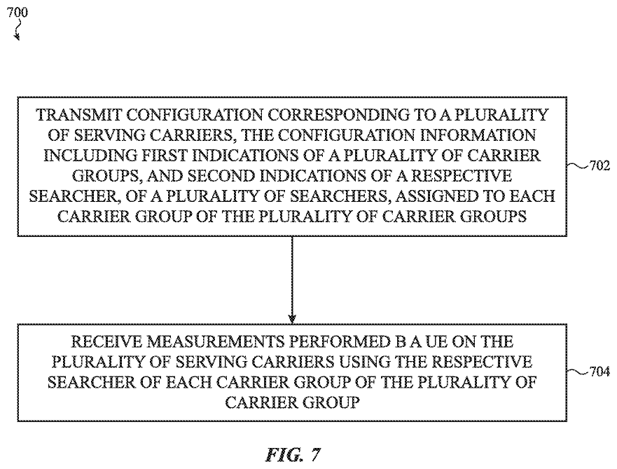

FIG. 7 illustrates another example flow-chart of operations that may be performed by a base station, according to embodiments described herein. As shown in a flow-chart 700, at 702, a base station may transmit, to a UE, configuration information corresponding to a plurality of serving carriers (CCs). The configuration information may include first indications of a plurality of carrier groups, and second indications of a respective searcher, of a plurality of searchers, assigned to each carrier group of the plurality of carrier groups.

The configuration information may also include, in some embodiments, and by way of a non-limiting example, a priority assigned to each carrier group of the plurality of carrier groups in which the respective searcher may perform search and measurement operations. In some embodiments, a searcher may be assigned more than one carrier group.

As described herein, the configuration information may be transmitted, by the base station, to the UE, via RRC signaling and/or a MAC CE. Each carrier group of the plurality of carrier groups may include a different subset of a plurality of CCs. In some embodiments, and by way of a non-limiting example, each subset of the plurality of CCs may be unique. In other words, each CC of the plurality of CCs may be present in not more than one carrier group.

In some embodiments, and by way of a non-limiting example, the indications may identify a set of one or more CCs included in a carrier group by at least one service cell ID, or at least one carrier frequency associated with a respective at least one CC. The CC may be in a frequency range of frequency range-1 (FR1) or a frequency range of frequency range-2 (FR2).

In some embodiments, and by way of a non-limiting example, a total number of CCs in a carrier group of the plurality of carrier groups may be limited to a predetermined number of serving carriers, and/or a total number of carrier groups of the plurality of carrier groups may be limited to a predetermined number of carrier groups.

At 704, the base station may receive, from the UE, measurements performed by the UE on the plurality of serving carriers using the respective searcher of each carrier group of the plurality of carrier groups, and based on the priority associated with each carrier group of the plurality of carrier groups. As described herein, a respective priority for each carrier group of the plurality of carrier groups may be transmitted to the UE in configuration information at 702. However, in some embodiments, and by way of a non-limiting example, when the priority corresponding to each carrier group is not included in the configuration information, the searcher of the UE may perform search and/or measurement operations in a round robin manner for each carrier group of the plurality of carrier groups.

Embodiments contemplated herein include an apparatus having means to perform one or more elements of the method 400, 500, 600, or 700. In the context of method 400 or 500, this apparatus may be, for example, an apparatus of a UE (such as a wireless device 902 that is a UE, as described herein). In the context of method 600 or 700, this apparatus may be, for example, an apparatus of a base station (such as a network device 920 that is a base station, as described herein).

Embodiments contemplated herein include one or more non-transitory computer-readable media storing instructions to cause an electronic device, upon execution of the instructions by one or more processors of the electronic device, to perform one or more elements of the method 400, 500, 600, or 700. In the context of method 400 or 500, this non-transitory computer-readable media may be, for example, a memory of a UE (such as a memory 906 of a wireless device 902 that is a UE, as described herein). In the context of method 600 or 700, this non-transitory computer-readable media may be, for example, a memory of a base station (such as a memory 924 of a network device 920 that is a base station, as described herein).

Embodiments contemplated herein include an apparatus having logic, modules, or circuitry to perform one or more elements of the method 400, 500, 600, or 700. In the context of method 400 or 500, this apparatus may be, for example, an apparatus of a UE (such as a wireless device 902 that is a UE, as described herein). In the context of method 600 or 700, this apparatus may be, for example, an apparatus of a base station (such as a network device 920 that is a base station, as described herein).

Embodiments contemplated herein include an apparatus having one or more processors and one or more computer-readable media, using or storing instructions that, when executed by the one or more processors, cause the one or more processors to perform one or more elements of the method 400, 500, 600, or 700. In the context of method 400 or 500, this apparatus may be, for example, an apparatus of a UE (such as a wireless device 902 that is a UE, as described herein). In the context of the method 600 or 700, this apparatus may be, for example, an apparatus of a base station (such as a network device 920 that is a base station, as described herein).

Embodiments contemplated herein include a signal as described in or related to one or more elements of the method 400, 500, 600, or 700.

Embodiments contemplated herein include a computer program or computer program product having instructions, wherein execution of the program by a processor causes the processor to carry out one or more elements of the method 400, 500, 600, or 700. In the context of method 400 or 500, the processor may be a processor of a UE (such as a processor(s) 904 of a wireless device 902 that is a UE, as described herein), and the instructions may be, for example, located in the processor and/or on a memory of the UE (such as a memory 906 of a wireless device 902 that is a UE, as described herein). In the context of method 600 or 700, the processor may be a processor of a base station (such as a processor(s) 922 of a network device 920 that is a base station, as described herein), and the instructions may be, for example, located in the processor and/or on a memory of the base station (such as a memory 924 of a network device 920 that is a base station, as described herein).

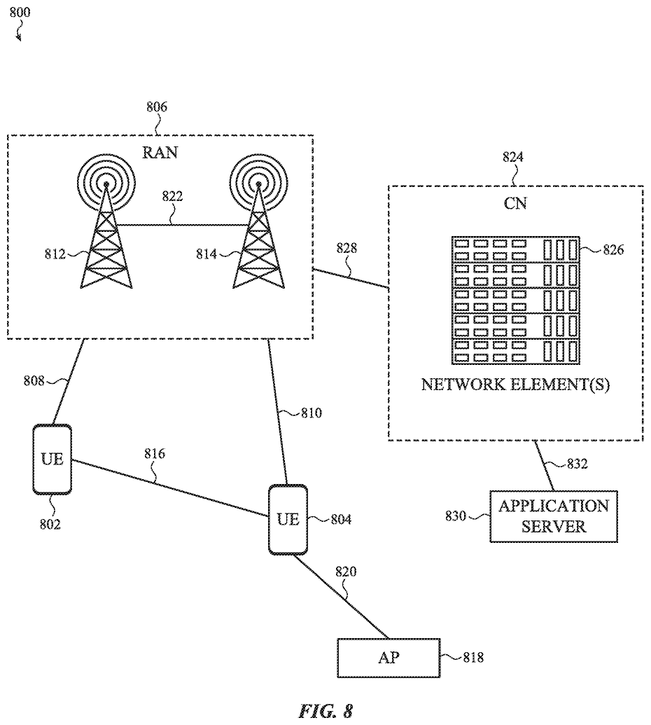

FIG. 8 illustrates an example architecture of a wireless communication system, according to embodiments described herein. The following description is provided for an example wireless communication system 800 that operates in conjunction with the LTE system standards and/or 5G or NR system standards as provided by 3GPP technical specifications.

As shown by FIG. 8, the wireless communication system 800 includes UE 802 and UE 804 (although any number of UEs may be used). In this example, the UE 802 and the UE 804 are illustrated as smartphones (e.g., handheld touchscreen mobile computing devices connectable to one or more cellular networks), but may also comprise any mobile or non-mobile computing device configured for wireless communication.

The UE 802 and UE 804 may be configured to communicatively couple with a RAN 806. In embodiments, the RAN 806 may be NG-RAN, E-UTRAN, etc. The UE 802 and UE 804 utilize connections (or channels) (shown as connection 808 and connection 810, respectively) with the RAN 806, each of which comprises a physical communications interface. The RAN 806 can include one or more base stations, such as base station 812 and base station 814, that enable the connection 808 and connection 810.

In this example, the connection 808 and connection 810 are air interfaces to enable such communicative coupling, and may be consistent with RAT(s) used by the RAN 806, such as, for example, an LTE and/or NR.

In some embodiments, the UE 802 and UE 804 may also directly exchange communication data via a sidelink interface 816. The UE 804 is shown to be configured to access an access point (shown as AP 818) via connection 820. By way of example, the connection 820 can comprise a local wireless connection, such as a connection consistent with any IEEE 602.11 protocol, wherein the AP 818 may comprise a Wi-Fi® router. In this example, the AP 818 may be connected to another network (for example, the Internet) without going through a CN 824.

In embodiments, the UE 802 and UE 804 can be configured to communicate using orthogonal frequency division multiplexing (OFDM) communication signals with each other or with the base station 812 and/or the base station 814 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 812 or base station 814 may be implemented as one or more software entities running on server computers as part of a virtual network. In addition, or in other embodiments, the base station 812 or base station 814 may be configured to communicate with one another via interface 822. In embodiments where the wireless communication system 800 is an LTE system (e.g., when the CN 824 is an EPC), the interface 822 may be an X2 interface. The X2 interface may be defined between two or more base stations (e.g., two or more eNBs and the like) that connect to an EPC, and/or between two eNBs connecting to the EPC. In embodiments where the wireless communication system 800 is an NR system (e.g., when CN 824 is a 5GC), the interface 822 may be an Xn interface. The Xn interface is defined between two or more base stations (e.g., two or more gNBs and the like) that connect to 5GC, between a base station 812 (e.g., a gNB) connecting to 5GC and an eNB, and/or between two eNBs connecting to 5GC (e.g., CN 824).

The RAN 806 is shown to be communicatively coupled to the CN 824. The CN 824 may comprise one or more network elements 826, which are configured to offer various data and telecommunications services to customers/subscribers (e.g., users of UE 802 and UE 804) who are connected to the CN 824 via the RAN 806. The components of the CN 824 may be implemented in one physical device or separate physical devices including components to read and execute instructions from a machine-readable or computer-readable medium (e.g., a non-transitory machine-readable storage medium).

In embodiments, the CN 824 may be an EPC, and the RAN 806 may be connected with the CN 824 via an S1 interface 828. In embodiments, the S1 interface 828 may be split into two parts, an S1 user plane (S1-U) interface, which carries traffic data between the base station 812 or base station 814 and a serving gateway (S-GW), and the S1-MME interface, which is a signaling interface between the base station 812 or base station 814 and mobility management entities (MMEs).

In embodiments, the CN 824 may be a 5GC, and the RAN 806 may be connected with the CN 824 via an NG interface 828. In embodiments, the NG interface 828 may be split into two parts, an NG user plane (NG-U) interface, which carries traffic data between the base station 812 or base station 814 and a user plane function (UPF), and the S1 control plane (NG-C) interface, which is a signaling interface between the base station 812 or base station 814 and access and mobility management functions (AMFs).

Generally, an application server 830 may be an element offering applications that use internet protocol (IP) bearer resources with the CN 824 (e.g., packet switched data services). The application server 830 can also be configured to support one or more communication services (e.g., VOIP sessions, group communication sessions, etc.) for the UE 802 and UE 804 via the CN 824. The application server 830 may communicate with the CN 824 through an IP communications interface 832.

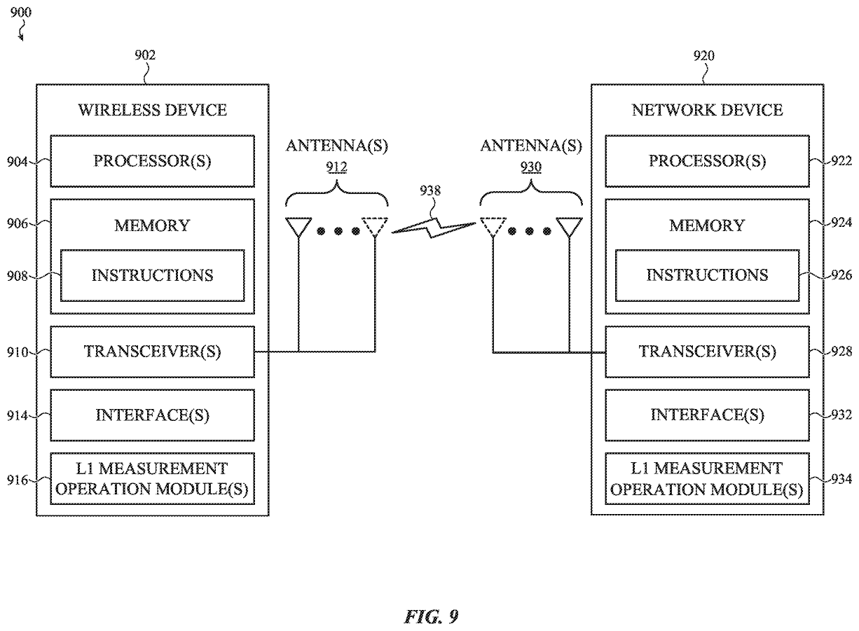

FIG. 9 illustrates a system 900 for performing signaling 938 between a wireless device 902 and a network device 920, according to embodiments described herein. The system 900 may be a portion of a wireless communication system as herein described. The wireless device 902 may be, for example, a UE of a wireless communication system. The network device 920 may be, for example, a base station (e.g., an eNB or a gNB) of a wireless communication system.

The wireless device 902 may include one or more processor(s) 904. The processor(s) 904 may execute instructions such that various operations of the wireless device 902 are performed, as described herein. The processor(s) 904 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 902 may include a memory 906. The memory 906 may be a non-transitory computer-readable storage medium that stores instructions 908 (which may include, for example, the instructions being executed by the processor(s) 904). The instructions 908 may also be referred to as program code or a computer program. The memory 906 may also store data used by, and results computed by, the processor(s) 904.

The wireless device 902 may include one or more transceiver(s) 910 that may include radio frequency (RF) transmitter and/or receiver circuitry that use the antenna(s) 912 of the wireless device 902 to facilitate signaling (e.g., the signaling 938) to and/or from the wireless device 902 with other devices (e.g., the network device 920) according to corresponding RATs.

The wireless device 902 may include one or more antenna(s) 912 (e.g., one, two, four, or more). For embodiments with multiple antenna(s) 912, the wireless device 902 may leverage the spatial diversity of such multiple antenna(s) 912 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 902 may be accomplished according to precoding (or digital beamforming) that is applied at the wireless device 902 that multiplexes the data streams across the antenna(s) 912 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 902 may implement analog beamforming techniques, whereby phases of the signals sent by the antenna(s) 912 are relatively adjusted such that the (joint) transmission of the antenna(s) 912 can be directed (this is sometimes referred to as beam steering).

The wireless device 902 may include one or more interface(s) 914. The interface(s) 914 may be used to provide input to or output from the wireless device 902. For example, a wireless device 902 that is a UE may include interface(s) 914 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 910/antenna(s) 912 already described) that allow for communication between the UE and other devices and may operate according to known protocols (e.g., Wi-Fi®, Bluetooth®, and the like).

The wireless device 902 may include an L1 measurement operation module 916. The L1 measurement operation module 916 may be implemented via hardware, software, or combinations thereof. For example, the L1 measurement operation module 916 may be implemented as a processor, circuit, and/or instructions 908 stored in the memory 906 and executed by the processor(s) 904. In some examples, the L1 measurement operation module 916 may be integrated within the processor(s) 904 and/or the transceiver(s) 910. For example, the L1 measurement operation module 916 may be implemented by a combination of software components (e.g., executed by a DSP or a general processor) and hardware components (e.g., logic gates and circuitry) within the processor(s) 904 or the transceiver(s) 910.

The L1 measurement operation module 916 may be used for various aspects of the present disclosure, for example, aspects of FIGS. 1, and 5-6, from the UE perspective. The L1 measurement operation module 916 may be configured to, for example, receive configuration information from a base station, and perform measurement operations, as described herein, in accordance with some embodiments, using FIG. 5 and/or FIG. 6.

The network device 920 may include one or more processor(s) 922. The processor(s) 922 may execute instructions such that various operations of the network device 920 are performed, as described herein. The processor(s) 922 may include one or more baseband processors implemented using, for example, a CPU, a DSP, an ASIC, a controller, an FPGA device, another hardware device, a firmware device, or any combination thereof configured to perform the operations described herein.

The network device 920 may include a memory 924. The memory 924 may be a non-transitory computer-readable storage medium that stores instructions 926 (which may include, for example, the instructions being executed by the processor(s) 922). The instructions 926 may also be referred to as program code or a computer program. The memory 924 may also store data used by, and results computed by, the processor(s) 922.

The network device 920 may include one or more transceiver(s) 928 that may include RF transmitter and/or receiver circuitry that use the antenna(s) 930 of the network device 920 to facilitate signaling (e.g., the signaling 938) to and/or from the network device 920 with other devices (e.g., the wireless device 902) according to corresponding RATs.

The network device 920 may include one or more antenna(s) 930 (e.g., one, two, four, or more). In embodiments having multiple antenna(s) 930, the network device 920 may perform MIMO, digital beamforming, analog beamforming, beam steering, etc., as has been described.

The network device 920 may include one or more interface(s) 932. The interface(s) 932 may be used to provide input to or output from the network device 920. For example, a network device 920 that is a base station may include interface(s) 932 made up of transmitters, receivers, and other circuitry (e.g., other than the transceiver(s) 928/antenna(s) 930 already described) that enables the base station to communicate with other equipment in a core network, and/or that enables the base station to communicate with external networks, computers, databases, and the like for purposes of operations, administration, and maintenance of the base station or other equipment operably connected thereto.

The network device 920 may include an L1 measurement operation module 934. The L1 measurement operation module 934 may be implemented via hardware, software, or combinations thereof. For example, the L1 measurement operation module 934 may be implemented as a processor, circuit, and/or instructions 926 stored in the memory 924 and executed by the processor(s) 922. In some examples, the L1 measurement operation module 934 may be integrated within the processor(s) 922 and/or the transceiver(s) 928. For example, the L1 measurement operation module 934 may be implemented by a combination of software components (e.g., executed by a DSP or a general processor) and hardware components (e.g., logic gates and circuitry) within the processor(s) 922 or the transceiver(s) 928.

The L1 measurement operation module 934 may be used for various aspects of the present disclosure, for example, aspects of FIGS. 1 and 6-7, from a base station perspective. The L1 measurement operation module 934 may be configured to, for example, transmit to the UE configurations as described herein, in accordance with some embodiments, using FIG. 6 and/or FIG. 7.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include logic for performing the operations or may include a combination of hardware, software, and/or firmware.

The systems described herein include descriptions of example embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A user equipment (UE), comprising:
a transceiver; and
a processor configured to,
receive, via the transceiver and from a base station, configuration information corresponding to a plurality of serving carriers, the configuration information comprising:
indications of a plurality of carrier groups, each carrier group of the plurality of carrier groups including a different subset of the plurality of serving carriers; and
a priority corresponding to each carrier group of the plurality of carrier groups; and
perform measurements on the plurality of serving carriers based on the priority associated with each carrier group of the plurality of carrier groups.

2. The UE of claim 1, wherein the indications of the plurality of carrier groups identify a set of one or more serving carriers included in a carrier group by: at least one serving cell ID, or at least one carrier frequency associated with a respective at least one serving carrier.

3. The UE of claim 1, wherein the configuration information is received via a radio resource control (RRC) signaling.

4. The UE of claim 1, wherein the plurality of serving carriers serve the UE in a frequency range of frequency range-1 (FR1) or a frequency range of frequency range-2 (FR2).

5. The UE of claim 1, wherein:
the processor is further configured to,
determine a measurement period for intra-frequency measurements based on a discontinuous reception (DRX) cycle time, a count of serving carriers in a carrier group of the plurality of carrier groups, and a respective priority of the carrier group.

6. The UE of claim 5, wherein the measurement period for intra-frequency measurements is determined for intra-frequency measurements without measurement gaps.

7. The UE of claim 6, wherein the measurement period for intra-frequency measurements without measurement gaps corresponds with a serving carrier in a frequency range of frequency range-1 (FR1).

8. The UE of claim 1, wherein a count of serving carriers in a carrier group of the plurality of carrier groups is limited to a predetermined number of serving carriers.

9. The UE of claim 1, wherein a count of carrier groups of the plurality of carrier groups is limited to a predetermined number of carrier groups.

10. A user equipment (UE), comprising:
a transceiver; and
a processor configured to,
receive, via the transceiver and from a base station, configuration information corresponding to a plurality of serving carriers, the configuration information comprising:
first indications of a plurality of carrier groups, each carrier group of the plurality of carrier groups including a different subset of the plurality of serving carriers; and
second indications of a respective searcher, of a plurality of searchers, assigned to each carrier group of the plurality of carrier groups; and
perform measurements on the plurality of serving carriers using the respective searcher of each carrier group of the plurality of carrier groups.

11. The UE of claim 10, wherein a searcher of the plurality of searchers is assigned to more than one carrier group of the plurality of carrier groups.

12. The UE of claim 11, wherein the configuration information further comprises a respective priority corresponding to each carrier group of the more than one carrier group of the plurality of carrier groups.

13. The UE of claim 10, wherein the first and the second indications of the plurality of carrier groups identify a set of one or more serving carriers included in a carrier group by: at least one serving cell ID, or at least one carrier frequency associated with a respective at least one serving carrier.

14. The UE of claim 10, wherein the configuration information is received via radio resource control (RRC) signaling or a MAC control element (MAC CE).

15. The UE of claim 10, wherein the plurality of serving carriers serve the UE in a frequency range of frequency range-1 (FR1) or a frequency range of frequency range-2 (FR2).

16. The UE of claim 10, wherein:
the processor is further configured to,
determine a measurement period for intra-frequency measurements based on a discontinuous reception (DRX) cycle time, a count of serving carriers in a carrier group of the plurality of carrier groups, and a respective priority of the carrier group.

17. The UE of claim 16, wherein the measurement period for intra-frequency measurements is determined for intra-frequency measurements without measurement gaps.

18. The UE of claim 17, wherein the measurement period for intra-frequency measurements without measurement gaps corresponds with a serving carrier in a frequency range of frequency range-2 (FR2).

19. A base station, comprising:
a transceiver; and
a processor configured to,
transmit, via the transceiver and to a user equipment (UE), configuration information corresponding to a plurality of serving carriers serving the UE, the configuration information comprising:
indications of a plurality of carrier groups, each carrier group of the plurality of carrier groups including a different subset of the plurality of serving carriers; and
a priority corresponding to each carrier group of the plurality of carrier groups; and
receive, via the transceiver and from the UE, measurements performed by the UE in accord with the indications and priorities for at least one carrier group in the plurality of carrier groups.

20. The base station of claim 19, wherein the configuration information further comprises second indications of a respective searcher, of a plurality of searchers, assigned to each carrier group of the plurality of carrier groups for performing cell detection and measurement operations.
